(19) United States
(12) Patent Application Publication
(10) Pub. No.: US 2004/0208162 A1
(43) Pub. Date: Oct. 21, 2004

(54) Method for maintaining and/or qualitatively improving a communication path in a relay system

(75) Inventors: Ansgar Bergmann, Valbonne (FR); Andreas Schenke, Bonn (DE); Bernd Gosele, Bonn (DE); Georg Surkamp, Krefeld (DE); Karl Eigler, Wachtberg (DE); Jorg Arnold, Bern (CH); Martin Lorang, Nohfelden (DE); Thomas Witthaut, Bonn (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: IP2H AG

(21) Appl. No.: 10/790,390

(22) Filed: Mar. 1, 2004

Related U.S. Application Data
(63) Continuation of application No. PCT/DE02/03162, filed on Aug. 28, 2002.

(30) Foreign Application Priority Data
Aug. 28, 2001 (DE) 101 41 335.1

(51) Int. Cl. H04L 12/56

(52) U.S. Cl. 370/351

(57) ABSTRACT

A method for maintaining and/or qualitatively improving a communication path in a relay system, in particular in a radio network, wherein information is transmissible between two devices (A₀, Aₙ) via one or more additional devices (A₁, . . . Aₙ₋₁) along a thus-formed communication path, and wherein at least one leg of the communication path can be replaced with a substitution path as a function of at least one predeterminable parameter, or be used at least at times simultaneously with a substitution path. The method permits maintaining a link quality at a high level, even when transmission conditions vary in the course of time.

### CROSS REFERENCE TO RELATED APPLICATION

The present application is a continuation of international application PCT/DE02/0316 filed 28 Aug. 2002, and which designates the U.S. The disclosure of the referenced application is incorporated herein by reference.

### BACKGROUND OF THE INVENTION

The present invention relates to a method for maintaining and/or qualitatively improving a communication path in a relay system, such as a radio network, wherein information is transmissible between two devices via one or more additional devices along the thus-formed communication path.

Within the scope of the present invention a relay system or communication system is understood to be a system which permits devices to transmit information directly to other devices, i.e., without the use of further devices. Whether or not two devices are able to communicate with each other directly, may depend on factors which vary in the course of time, for example, because the devices move, or the transmission paths and/or transmission characteristics change.

Within the scope of the present invention, a relay system is understood to be a communication system in the above meaning, which permits exchanging information between a device A₀ and a device A₀(n>1), via a series of devices A₁, . . . to Aₙ₋₁, which function as intercarriers. In this process, the device Aᵢ directly communicates with the device Aᵢ₊₁ by means of a transmission technology TTᵢ₊₁ (i=0, . . . , n−1). This connection between A₀ and Aₙ via the series of devices A₀, A₁, . . . , Aₙ₋₁, Aₙ by means of the transmission technologies TTᵢ₊₁ (i=0, . . . , n−1) is called communication path, and expressed as

A₀−TT₁−A₁−TT₂−A₂. . . Aₙ₋₂−TTₙ₋₁−Aₙ₋₁−TTₙ−Aₙ.

The direct connection by means of the transmission technology TTᵢ₊₁ between two devices Aᵢ and Aᵢ₊₁(0<i<n) is called a link and expressed as

Aᵢ−TTᵢ₊₁−Aᵢ₊₁.

Devices of the relay system, which are capable of functioning as intercarriers are called relays. An end device may simultaneously be a relay. A part of the communication path between relay Aₖ and A₁ (0<k<l<n) via the series of devices Aₖ, Aₖ₊₁, . . . , Aₗ₋₁, Aₗ by means of the transmission technologies TTᵢ₊₁ (i=k, . . . , l) is called leg and expressed as

Aₖ−TTₖ₊₁−Aₖ₊₁−TTₖ₊₂−Aₖ₊₂ . . . Aₗ₋₂−TTₗ₋₁−Aₗ₋₁−TTₗ₋Aₗ.

In a relay system, devices are thus able to communicate with one another via paths. Unlike other communication networks, for example, the currently known cellular mobile radio networks, such as, for example, GSM, UMTS, PDC, CDMA2000, IS95, a relay system permits all relays performing the same relay functions within the scope of their physical capabilities. In this meaning, examples for relay systems are radio relay systems, the Internet, Intranets, and Local Area Networks.

In a relay system, the connection quality via a communication path is subjected to time variations. In this connection, there exists a dependency, among other things, on the transmission quality of the individual links and on the load situations in the relay system. The quality of the relay system is largely defined by the possibility of being able to select communication paths of a better quality of service (QoS). Known methods of the art provide this in a way that is not satisfactory for relay systems.

It is therefore an object of the present invention to provide a method for maintaining and/or qualitatively improving a communication path in a relay system, which permits maintaining the link quality at a high level, even when transmission conditions vary in the course of time.

### SUMMARY OF THE INVENTION

In accordance with the invention, the foregoing object is accomplished by a method wherein at least one leg of the communication path can be replaced with a substitution path as a function of at least one predeterminable parameter, or be used at least at times simultaneously with a substitution path.

In a method according to the invention, it has been found with respect to one aspect of the invention that the exchange of at least one leg of the communication path for a more suitable leg, accomplishes the foregoing object in a surprisingly simple manner. Such an exchange or substitution step could occur as a function of at least one predeterminable parameter. As an alternative, the at least one leg of the path could be usable at least at times simultaneously with a more suitable leg of the path, namely the substitution path. Likewise, this at least temporarily simultaneous use could occur as a function of at least one predeterminable parameter. As a parameter, it would be possible to use a predeterminable quality threshold value.

A limitation concerning the legs of the communication path that are to be substituted is absent. A substitution or simultaneous use is possible in any point and along any desired number of links of the communication path. In most cases, it is not necessary to substitute the communication path as a whole.

Consequently, the method of the invention indicates a method, which permits maintaining the link quality at a high level, even in the case of transmission conditions that vary in the course of time.

As regards a reliable implementation of the method according to the invention, one could assign a connection identifier to the connection that is defined or produced between the two devices. This identifier could be unambiguous as long as there are devices, for which the connection is found existing. The connection identifier could consist of an identifier of the one device A₀ in the relay system, which is unambiguous at a predeterminable time, and of a temporary identifier, preferably selected by A₀. After the path for A₀ no longer exists, A₀ will not newly assign this temporary identifier during a period, which is adequately long, so that the devices of the system consider the path no longer existing.

Furthermore, with respect to a reliable implementation of the method, it would be possible to communicate to A₀ and/or the end device Aₙ, each change of a path of the devices, relays and/or end devices, that are involved in the path change. Furthermore, one could assign to the path a path identifier that is unambiguous at a given time and, preferably, takes into account each path change.

Furthermore, with respect to a reliable method, one could assign to at least one device Aᵢ (i=0, . . . n) in the path a device identifier for each exchange of information via the path. In a particularly simple manner, this device identifier could consist of the path identifier and the position i in the path.

Depending on need, it would be possible to assign the connection identifier, and/or the temporary identifier, and/or the path identifier, and/or the device identifier by one or both of the two devices A₀ and/or Aₙ, which are each arranged at the ends of the communication path.

In the relay system, a relay that can directly communicate with a device Aᵢ, is called an adjacent relay of Aᵢ. A relay adjoining an adjacent relay of Aᵢ is called an adjacent relay of the second order of Aᵢ. In general, for an integer n>0, a relay adjoining an adjacent relay of the nth order of Aᵢ is called an adjacent relay of the (n+1)th order of Aᵢ.

To ensure a reliable sequence of the process, one could provide in the relay system that each device exchanges data with its adjacent relay. These data could comprise in particular the identifications of existing connections and/or paths, connection identifiers and/or path identifiers, and/or the position i in the path of neighbors of a predeterminable order. In a particularly reliable manner, the exchange of data could occur periodically. A device Aᵢ pertaining to an existing path could use these data to develop or generate substitute paths.

Concretely, a device Aᵢ will be able to designate an adjacent relay D of the first order a substitution candidate, when the adjacent relay D has been for a predeterminable time the adjacent relay of the first order of Aᵢ and belongs to the same connection and/or the same path, but is neither Aᵢ₋₁ nor Aᵢ₊₁. To this, one could add as an additional facultative condition that a link quality between the device Aᵢ and the adjacent relay D include or exceed a predeterminable quality.

In this connection, it is only necessary to exchange the identifications of existing connections or paths of neighbors up to the first order. As an alternative, each device participating in the path could transmit via the path at least one of its identities or identifiers to all other devices of the path or to the nearest K devices, if present, in both directions of the path. As an alternative or in addition, each device could transmit the same identity to its neighbors of the first or a predeterminable higher order. The identity or identifier could be device-specific and/or subscriber-specific. Preferably, the value K could be predeterminable by the relay system. Furthermore, the value K could be at least temporarily reducible preferably by a device, when a signaling load exceeds a predeterminable value.

In an alternative sequence of the process for determining a substitution candidate, one could use in particular a relay that belongs to a path for transmitting the path identifier P and the position i to its adjacent relays of the first order. Furthermore, information could be communicated in the relay system via a device in the path to as far as 1th neighbors of devices of the path, so that a device that is an mth neighbor of a device in the path (m≦1) knows at least one neighbor of the (m−1)th order of the device in the path.

A device Aᵢ, which occupies in a loopfree path with the path identifier P the position i will then be able to designate an adjacent relay D a substitution candidate, when a relay occupying in the path with the path identifier P the position k in the path is known to this adjacent relay D as adjacent relay of the lth order, and when the adjacent relay D is for a predeterminable time an adjacent relay of the first order of Aᵢ, and when preferably a link quality between the device Aᵢ and the adjacent relay D has or exceeds a predeterminable quality.

A further process of detecting a substitution candidate could proceed as follows:

Each device of the path initially communicates to the other devices of the path one of its identities and/or identifiers by signaling on the path. The identities and/or identifiers could be subscriber-specific and/or device-specific. In the above-described exchange of information with adjacent devices, the same identity is periodically transmitted instead of the path identifier and position in the path. With that, a device Aᵢ of a path

A₀−TT₁−A₁−TT₂−A₂. . . Aₙ₋₂−TTₙ₋₁−Aₙ₋₁−TTₙ−Aₙ

is able to detect that besides Aᵢ₊₁ and Aᵢ₋₁—or besides Aᵢ₊₁, when i=0, or besides Aₗ₋₁, when i=n—an additional relay of the same path is a neighbor of the nth order.

A further process for detecting a substitution candidate could proceed as follows:

To begin with, devices or relays could exchange with their adjacent relays of the first order adjacency information about their adjacent relays of the lth order. The adjacency information could comprise the identity and the order of the adjacency. On existing paths, each device participating in the path could transmit via the path the adjacency information to all other devices of the path or to the nearest K devices, if present, in both directions of the path.

It will be possible to designate an adjacent relay of the first order a substitution candidate, when the adjacent relay is simultaneously known to a relay that occupies in the path with the path identifier P the position k, as adjacent relay of an order that is <1.

The aforesaid values 1 and/or K could preferably be predeterminable by the system. If a signaling load exceeds a predeterminable value, the values 1 and/or K could be reducible at least temporarily. The reduction could be performed by a predeterminable device.

Before a substitution step in accordance with the invention, it would be possible to perform an examination proceeding, which would determine whether a substitution step has to occur. More specifically, to examine whether a link between two devices or relays is disturbed or interrupted, or assumed to be disturbed or interrupted, one could perform in a very simple manner a link diagnosis and/or link signaling.

Concretely, when proceeding from a transmission technology TTᵢ₊₁ that is used between the device Aₗ and the device Aᵢ₊₁, this transmission technology could typically make available a link diagnosis and/or information for a link diagnosis, which are capable of indicating or permitting the conclusion that a link is disturbed or interrupted, or assumed to be disturbed or interrupted. For example, the link diagnosis could permit information about the transmission power, receiving power, signal strength of the received signal, and/or their variation. When the relay system provides a link signaling in each link of a path, this link signaling may be used for diagnosing a disturbance or interruption of the link. More specifically a link disturbance is present, when the bit error rate or frame error rate of the link signaling or a combination of both is too high. A link interruption, however, is present, when the link signaling is interrupted.

Such a test could also be used for rating the quality and/or quality of service of the path or leg thereof. More specifically, this could occur, when it is known, when errorfree frames are transmitted from one end of the path or leg of the path by evaluating the bit error rate, the frame error rate, or the throughput, or a combination thereof.

It is likewise possible to rate the quality of service of the path or a leg of the path for an application, when parameters exceed or fall below certain threshold values, which are regulated by regulating mechanisms that are controlled by the application. Examples of such parameters are window sizes, values of timers, or counters.

Concretely, a device Aᵢ could perform a local substitution of a leg of the path, or enable a simultaneous usability of a substitution path, when the link to Aₗ(j=i−1 or i+1) is interrupted or too greatly disturbed, and/or threatens to be interrupted or too greatly disturbed, and when Aᵢ identifies one or more substitution candidates. Such a situation could be diagnosed by Aᵢ, which could cause Aᵢ to decide on performing the substitution process either by a local substitution or by the simultaneous utilization of a substitution path. Such a local substitution could also be called a local handover. The substitution process will not occur, only when Aᵢ omits this because of a method that is applied for preventing overlapping substitution processes.

As an alternative thereto, a device Aᵢ could perform a local substitution of a leg or enable a simultaneous usability of a substitution path, when, according to information known to Aᵢ, it is possible to replace an existing leg of the path originating at Aᵢ with a new leg of a shorter length that passes through a substitution candidate R. To this end, a device Aᵢ in a loopfree path could consider as substitution candidate an adjacent relay R that is not in the path. In this connection, Aᵢ could decide whether a substitution process is to be performed. The substitution process will not be performed, only when Aᵢ omits this because of a method that is applied for preventing overlapping substitution processes.

Basically, a local substitution could be initiated in a very simple manner by requesting the substitution candidate to continue to establish the new leg of the path. Based on the information available to it, the substitution candidate could address the nearest relay of the path being formed, and this operation could continue stepwise via additional relays. As a result of forwarding the request from the substitution candidate to further, suitable relays, it would be possible to form a new leg of the path to Aⱼ.

In a further alternative, a device Aₗ (i=0 or n) could perform a global substitution, if the quality of the path from Aᵢ to Aⱼ (j=0, or j=n; j≈i) or Aᵢ₋₁ (i>0) falls below a predeterminable quality. In this case, Aᵢ could decide after a corresponding diagnosis by Aᵢ, to perform a global substitution or a so-called global handover. The substitution process will not be performed, only when Aₗ omits this because of a method that is applied for preventing overlapping substitution processes.

When a device Aₗ starts to perform a local substitution to Aⱼ, it knows at least one substitution candidate as well as the length of the potentially new legs that are to be formed by the at least one substitution candidate. Typically, the device Aᵢ also knows a rating of the—possibly potential—link to at least one substitution candidate, which is performed by the respective transmission technology or because of data of the respective transmission technology. Aᵢ will then select a substitution candidate, while suitably taking account of this information. It will establish a link to this candidate, and transmit the request to further establish the new leg of the path.

When A₀ starts to perform a global substitution, A₀ will establish a connection to Aₙ according to a proceeding that is predetermined in the relay system. The substitution candidate could perform a global substitution by establishing a path between A₀ and Aₙ according to a nondeterministic method of establishing a path and/or a method that takes into account the network status or the status of the relay system, so that in all likelihood the substitution path differs from the original path. When the device An starts to perform a global substitution to A₀ it will proceed in an analogous manner.

In a further analogous manner, the substitution candidate could perform a global substitution by establishing a path between Aᵢ and Aⱼ according to a nondeterministic method of establishing a path and/or a method that takes into account the network status or status of the relay system, so that in all likelihood the substitution path differs from the original path.

Within the scope of a particularly simple substitution process, it would be possible to begin in the case of a local or global substitution with the establishment of a signaling connection. Once this connection is established, and the quality is adequately satisfactory, it would be possible to switch the service connection from the previous path to the modified or new path. This process will not be possible, when the previous or original path is interrupted. In this case, the service connection will be switched as early as possible to the modified or new substitution path.

With regard to a reliable transmission of information, a service connection could use in the case of a global substitution, both or several paths—the original and the new path or the new paths—until the original or one of the new paths has exceeded a quality threshold value. It would then be possible to use only the path of the best quality. Subsequently, i.e., after exceeding the quality threshold value, it would be possible to disconnect less suited paths.

While in the last-described process both or several paths are used, it would be possible to prefer the better-transmitted information, or to combine the information. To this end, a transmission could be performed in packets that are sequenced by identification.

In particular, when changing delays that exceed a predetermined maximum fluctuation are not acceptable in the transmission of user information, whereas a predetermined maximum delay is acceptable, it will be possible to buffer at the respective destination the user information that is to be transmitted, so that when connecting a new, shorter path, the predetermined maximum fluctuation of the delay is not exceeded. This represents a particularly reliable transmission method.

In practice, two or more participating relays or devices often find within the same period that a substitution process is required. To avoid that two or more devices initiate a substitution process, and that therefore resources are needlessly used, or that even blockings occur, it would be possible to prioritize relays. In so doing, it would be possible to determine already during the path establishment or during a communication, which relay or relays is or are authorized to perform a substitution. As an alternative or in addition, it would be possible to use the knowledge of the own location as well as the location of neighbors in the connection for assigning a distribution of tasks. Thus, it would be possible to authorize the device or relay nearest to a source or destination to perform a substitution. In this connection, it is also of advantage that in the case of interruptions of several adjacent links, it is always possible to allocate in a unambiguous manner the node, or device, or relay that initiates a substitution.

The position in a connection chain can be derived from the hop count or from observing the flow of data or the establishment of the path.

Within the scope of the substitution process, it is useful to disconnect legs of the path that are no longer needed. With respect to such a disconnection of no longer needed paths or legs thereof, it would be possible to compare packets for determining the direction, in which the newly detected relay or substitution candidate is located. As an alternative or in addition, one could use a test packet for determining the direction. As a further alternative or in addition thereto, the position of the substitution candidate in the path could be communicated to the device Aᵢ.

With respect to a substitution adapted to the respective case of application, it would be possible to perform a substitution as a function of the application. Thus, it is possible to perform for one or more applications using one path, a substitution to a new path or a substitution with two or more simultaneously usable paths.

As regards a particularly individual adaptation of the communication path to existing requirements, it would be possible to use different transmission technologies between the individual devices or relays. The applied transmission technologies may use, for example, a radio transmission, a line-connected transmission, a light wave transmission, an acoustic transmission, or other types of transmission.

Basically, it should be remarked at this point that in the foregoing specification, the expression substitution process stands for both replacing a path or a leg thereof with a substitution path and simultaneously utilizing at least temporarily an original path or a leg thereof and a substitution path or a plurality of substitution paths. In this connection, the expression substitution process comprises both the local and the global substitution or a local and a global handover.

At this point, it should also be pointed out that the parameters i, k, K, l , m, and n as used in this specification stand for positive natural numbers including zero.

There exist various possibilities of improving and further developing the teaching of the present invention in an advantageous manner. To this end, one may refer to the following description of a preferred embodiment of the invention with reference to the drawing. In conjunction with the description of the preferred embodiment of the invention with reference to the drawing, also generally preferred improvements and further developments of the invention are described in detail.

### BRIEF DESCRIPTION OF THE DRAWINGS

In the drawing:

FIG. 1 is a diagram of a typical establishment of a communication path in a relay system;

FIG. 2 is a diagram of a communication path, which comprises six devices; and

FIG. 3 is a diagram of a communication path with a parallel-illustrated substitution path.

### DETAILED DESCRIPTION OF THE PREFERRED EMBODIMENTS

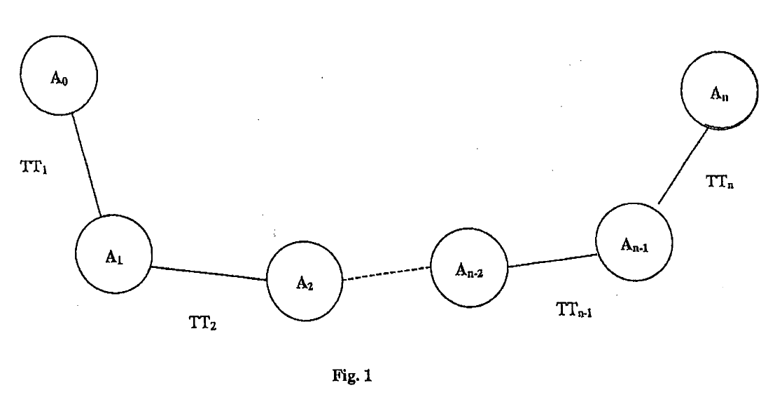

FIG. 1 illustrates a diagram of a typical communication path comprising devices of a relay system. The communication path starts with a device A₀ and ends with a device Aₙ. TTₗ and TTₙ further indicate the transmission technologies used between the devices. These transmission technologies may differ from link to link between the devices.

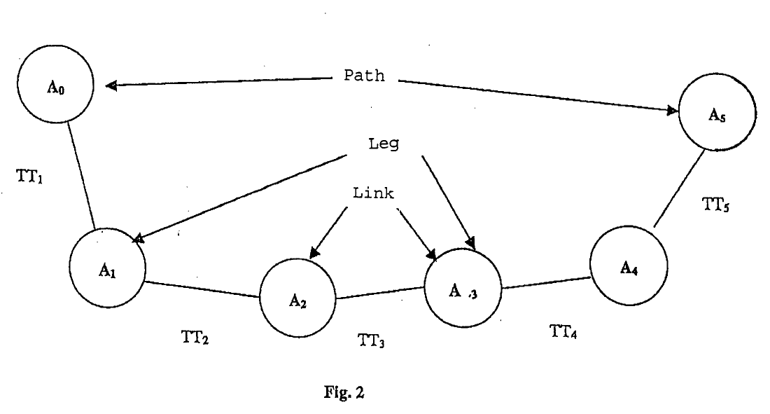

Likewise, FIG. 2 shows a diagram of a communication path, which extends from a device A₀ to a device A₅. Between the devices, the transmission technologies TTₗ to TT₅ are used. The expression “leg” denotes a segment of the communication path between the device A₁ and the device A₃. A “link” indicates a direct connection between two devices that are adjacent in the communication path, in the Figure A₂ and A₃.

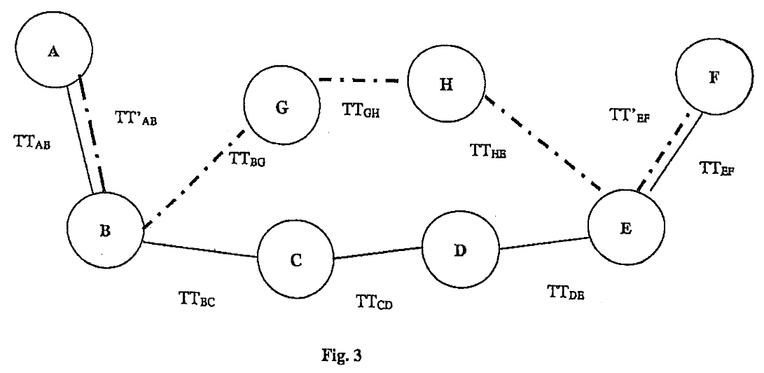

FIG. 3 shows a diagram of a communication path from a device A to a device F. Also shown is a simultaneously usable substitution path, which likewise extends from the device A to the device F. However, the connection passes through two additional devices G and H. The original communication path thus extends via the devices A, B, C, D, E, and F, and the substitution path via the devices A, B, G, H, E, and F. Between the individual devices, the transmission technologies are indicated at TT and TT′ respectively. The path configuration shown in FIG. 3 avoids a loop.

In the configuration shown in FIG. 3, it is of special importance that both the original communication path and the substitution path comprise a comparable direct connection respectively between the devices A and B as well as E and F. Only between the devices B and E do the paths pass through different devices, namely on the one hand through devices C and D, and on the other hand through devices G and H.

As regards further advantageous improvements and further developments of the invention, the general part of the specification on the one hand and the attached claims on the other hand are herewith incorporated by reference for avoiding repetitions.

Finally, it should be expressly remarked that the above, merely arbitrarily selected embodiment serves only to explain the teaching of the invention, without however limiting it to this embodiment.

1. A method for maintaining and/or qualitatively improving a communication path in a relay system, wherein information is transmissible between two devices (A₀, Aₙ) via one or more additional devices (A₁, . . . , A₋₁) along the thereby formed communication path, and wherein at least one leg of the communication path is replaceable with a substitute path as a function of at least one predeterminable parameter, or usable at least at times simultaneously with a substitute path.

2. The method of claim 1, wherein a connection identifier is assigned to the connection that is defined or produced between the two devices (A₀, Aₙ)

3. The method of claim 2, wherein the connection identifier comprises an unambiguous identity of A₀ in the relay system at a predeterminable time and a provisional temporary identifier which is selected by A₀.

4. The method of claim 1, wherein each change of a path is communicated to A₀ and/or Aₙ by the relays and/or end devices that participate in the path change.

5. The method of claim 1, wherein a path identifier is assigned to the path, which is unambiguous at a given time, and takes account of each change in the path.

6. The method of claim 1, wherein a device identifier for each information exchange via the path is assigned to at least one device Aᵢ (i =0, . . . n) that participates in the path.

7. The method of claim 6, wherein the device identifier comprises the path identifier and the position i in the path.

8. The method of claim 2, wherein the connection identifier and/or the temporary identifier and/or the path identifier and/or the device identifier is or are assigned by A₀ and/or Aₙ.

9. The method of claim 1, wherein each device exchanges with its adjacent relay information, preferably the identifiers of existing connections and/or paths and/or the position i in the path of neighbors of a predeterminable order.

10. The method of claim 9, wherein the exchange of information occurs periodically.

11. The method of claim 1, wherein a device A₁ designates an adjacent relay D of the first order as substitution candidate, when the adjacent relay D is an adjacent relay of the first order of Aᵢ for a predeterminable time and belongs to the same connection and/or same path, but is neither Aᵢ₌₁ nor Aᵢ₊₁, and that a link quality between the device Aᵢ and the adjacent relay D has or exceeds a predeterminable quality.

12. The method of claim 1, wherein each device participating in the path transmits via the path at least one of its identities to all other devices of the path or to the nearest K devices in both directions of the path.

13. The method of claim 1, wherein each device transmits the same identity to its neighbors of the first or a predeterminable higher order.

14. The method of claim 13, wherein the identity is device-specific and/or subscriber-specific.

15. The method of claim 1, wherein the value K is predeterminable.

16. The method of claim 15, wherein the value K is at least temporarily reducible, when a signaling load exceeds a predeterminable value.

17. The method of claim 5, wherein a relay participating in a path transmits the path identifier P and the position i in the path to its adjacent relays of the first order.

18. The method of claim 1, wherein in the relay system information is communicated via a device in the path to as far as lth neighbors of devices of the path, so that a device that is an mth neighbor of a device in the path (m≦l) knows at least one neighbor of the (m−1)th order of the device in the path.

19. The method of claim 5, wherein a device Aₗ, which occupies the position i in a loopfree path with the path identifier P, designates an adjacent relay D a substitution candidate, when this adjacent relay D knows as adjacent relay of the lth order, a relay that occupies in the path with the path identifier P the position k in the path, and when the adjacent relay D is an adjacent relay of the first order of Aᵢ for a predeterminable time, and when preferably a link quality between the device Aₗ and the adjacent relay D has or exceeds a predeterminable quality.

20. The method of claim 1, wherein devices or relays exchange adjacency information with their adjacent relays of the first order via their adjacent relays of the lth order.

21. The method of claim 20, wherein the adjacency information comprises the identity and the order of the adjacency.

22. The method of claim 20, wherein each device participating in the path transmits via the path the adjacency information to all other devices of the path or to the nearest K devices in both directions of the path.

23. The method of claim 5, wherein an adjacent relay of the first order is designated a substitution candidate, when the adjacent relay is simultaneously known to a relay occupying the position k in the path with the path identifier P as an adjacent relay of an order smaller than 1.

24. The method of claim 23, wherein the value 1 and/or K is predeterminable.

25. The method of claim 24, wherein the value 1 and/or K is at least temporarily reducible, when a signaling load exceeds a predeterminable value.

26. The method of claim 1, wherein for examining whether a link between two devices or relays is disturbed or interrupted or is assumed to be disturbed or interrupted, a link diagnosis and/or link signaling is performed.

27. The method of claim 1, wherein the quality and/or the quality of service of the path or leg thereof is rated.

28. The method of claim 1, wherein a device Aₗ performs a local substitution of a leg of the path or enables a simultaneous usability of a substitution path, when the link to Aⱼ(j=i=1 or i+1) is interrupted or greatly disturbed and/or threatens to be interrupted or greatly disturbed, and when Aᵢ knows one or more substitution candidates.

29. The method of claim 1, wherein a device Aᵢ performs a local substitution of a leg of the path, or enables a simultaneous usability of a substitution path, when according to the data known to Aⱼ an existing leg of the path that proceeds from Aⱼ can be replaced with a new leg of a shorter length that passes through a substitution candidate R.

30. The method of claim 1, wherein a local substitution is initiated by requesting the substitution candidate to further establish the new leg of the path.

31. The method of claim 30, wherein the request is forwarded by the substitution candidate to further suitable relays.

32. The method of claim 1, wherein a device Aᵢ (i=0 or n) performs a global substitution, when the quality of the path from Aᵢ to Aⱼ (j=0 or j=n; j≠i) or Aᵢ₋₁ (i>0) falls below a predeterminable quality.

33. The method of claim 1, wherein the substitution candidate performs a global substitution by establishing a path between A₀ and Aₙ according to a nondeterministic method of establishing a path and/or a method that takes into account the network status or the status of the relay system, so that in all likelihood the substitution path differs from the original path.

34. The method of claim 11, wherein the substitution candidate performs a global substitution by establishing a path between Aᵢ and Aⱼ according to a nondeterministic method of establishing a path and/or a method that takes into account the network status or the status of the relay system, so that in all likelihood the substitution path differs from the original path.

35. The method of claim 34, wherein in the case of a local or a global substitution, a signaling connection is initially established.

36. The method of claim 1, wherein in the case of the global substitution, a service connection uses both or several paths, the original and the new path or the new paths, until the original path or one of the new paths exceeds a quality threshold value.

37. The method of claim 36, wherein after exceeding the quality threshold value, less suited paths are disconnected.

38. The method of claim 1, wherein the user information that is to be transmitted can be buffered at the respective destination.

39. The method of claim 1, wherein it is determined during the establishment of a path or during a communication connection, which relay or relays is or are authorized to perform a substitution.

40. The method of claim 1, wherein the device or relay nearest to a source or a destination is authorized to perform a substitution.

41. The method of claim 1, wherein with respect to disconnecting no longer needed paths or legs thereof, packet comparisons occur, and/or a test packet is used, and/or the position of the substitution candidate in the path is communicated to Aᵢ.

42. The method of claim 41, wherein a substitution is performed as a function of the application.

43. The method of claim 42, wherein it is possible to use different transmission technologies between the individual devices or relays.
